(19) United States
(12) Patent Application Publication
(10) Pub. No.: US 2011/0013799 A1
(43) Pub. Date: Jan. 20, 2011

(54) WATERPROOF MICROPHONE

(75) Inventors: TAO FANG, Shenzhen (CN); TIE-SHAN HE, Shenzhen (CN)

Correspondence Address: Jamie Zheng, 3524 Waverley Street, Palo Alto, CA, 94306, US

(73) Assignees: AAC ACOUSTIC TECHNOLOGIES (SHENZHEN) CO., LTD, Shenzhen (CN); AMERICAN AUDIO COMPONENTS INC., La Verne, CA (US)

(21) Appl. No.: 12/697,286

(22) Filed: Jan. 31, 2010

(30) Foreign Application Priority Data
Jul. 17, 2009 (CN) 200920133690.2

(51) Int. Cl. H04R 11/04

(52) U.S. Cl. 381/355

(57) ABSTRACT

A waterproof microphone includes a transducer unit defining a sound receiving opening, a first waterproof layer fully covering the sound receiving opening, and a second waterproof layer spaced from the first waterproof layer for forming a closed decompression chamber.

### FIELD OF THE INVENTION

The present invention relates to the art of microphones, and more specifically, to a microphone having waterproof structures.

### BACKGROUND OF THE INVENTION

Waterproof microphones are widely used in portable deceives, such as notebooks, mobile phones, etc. The microphone generally includes a cylinder-shaped case, and a transducer cased in the case. In order to protect the transducer from water or dust, a ventilated film is provided to cover a sound hole of the transducer. The sound hole is used to receive sound waves into the transducer for activating a diaphragm to vibrate for changing the distance between two electrodes of a capacitor, which converts sound waves into electrical signals. In order to meet the real applied environment, contemporary electronic devices, such as mobile phones, should be highly protected from water. For example, a mobile phone can still work after being immersed for thirty minutes at a depth of one meter in the water. For achieving the high protecting level, components used in the mobile phone should pass the waterproof test Level IPX-7. However, a microphone only having a ventilated film cannot pass the IPX-7 Test. Water can still enter the transducer used in the microphone. Therefore, an improved microphone is needed to solve the problem mentioned above.

### SUMMARY OF THE INVENTION

Accordingly, embodiments of the present invention are made to resolve the problem mentioned above. According to an aspect of the present invention, a waterproof microphone includes a transducer unit defining a sound receiving opening, a first waterproof layer fully covering the sound receiving opening, and a second waterproof layer spaced from the first waterproof layer for forming a closed decompression chamber.

Other features and advantages of the present invention will become more apparent to those skilled in the art upon examination of the following drawings and detailed description of exemplary embodiments.

### BRIEF DESCRIPTION OF THE DRAWINGS

FIG. 1 is a cross-sectional view of a microphone in accordance with a first embodiment of the present invention; and

FIG. 2 is a cross-sectional view of a microphone in accordance with a second embodiment of the present invention.

### DETAILED DESCRIPTION OF EMBODIMENTS OF THE INVENTION

Reference will now be made to describe the embodiments of the present invention in detail.

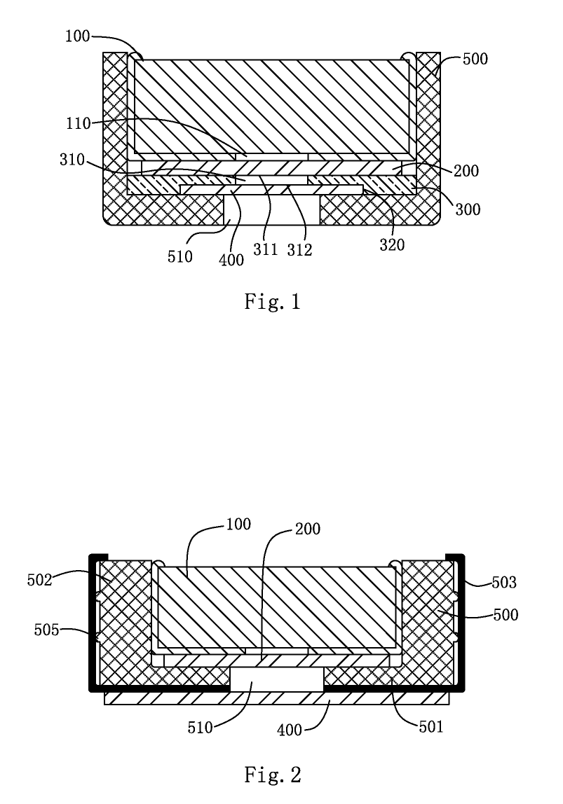

Referring to FIG. 1, a waterproof microphone, in accordance with a first embodiment of the present invention, comprises a transducer unit 100 defining a sound receiving opening 110. In order to avoid water dropping into the transducer unit 100, a first waterproof layer 200 is attached to the transducer unit 100 and fully covers the sound receiving opening 110. The waterproof microphone further includes a board 300 abutting against the first waterproof layer 200, and a second waterproof layer 400 coupled to the board 300. The board 300 may be a water-resistant gasket which is made of plastic, or rubber. The first waterproof layer 200 is spaced from the second waterproof layer 400 by the board 300. The board 300 defines a central hole 310 covered by the second waterproof layer 400. As shown in FIG. 1, the central hole 310 is a closed space surrounded by the first waterproof layer 200, the board 300 and the second waterproof layer 400. The closed central hole 310 serves as a decompression chamber.

The second waterproof layer 400 can be pasted directly onto the board 300. In order to reduce the height of microphone, the board 300 defines a concave area 320, and the second waterproof layer 400 is accommodated in the concave are 320. The second waterproof layer 400 may be entirely accommodated in the concave area 320.

In addition, the waterproof microphone includes a housing 500 packing the combination of the transducer unit 100, first waterproof layer 200, the board 300 and the second waterproof layer 400. The housing 500 defines a sound hole 510 fully covered by the second waterproof layer 400. The house 500 is made of rubber or plastic. The waterproof layers are made of thin films having billions of stomas. Diameter of each stoma is ten thousand times smaller than that of water drop and is hundred times greater than that of gas molecule. Therefore, gas, such as air, can easily go through the waterproof layers and, however, the water can not pass the layers.

FIG. 2 illustrates a waterproof microphone in accordance with a second embodiment of the present invention. In brief, the differences between the first and second embodiments are that the board in the first embodiment is cancelled, and that the second waterproof layer 400 is moved outside. The first waterproof layer 200 covers the sound receiving opening. The housing 500 includes a top 501 and a side 502 extending perpendicularly from the top 501 for providing a space for accommodating the transducer 100. The top 501 defines a sound hole 510 with one side covered by the first waterproof layer 200 and another side covered by the second waterproof layer 400. Thus, the sound hole 510 is closed by the top 501, the first waterproof layer 200 and the second waterproof layer 400. The sound hole 510 serves as a decompression chamber. In this embodiment, the microphone further includes a shell 503 covering the housing 500. A plurality of protrusions 505 is arranged between the housing and the shell for firmly assembling them.

In brief, disclosures of the present invention provide waterproof microphone including two waterproof layers spaced form each other by a member, such as the board or the top.

While the present invention has been described with reference to the specific embodiments, the description of the invention is illustrative and is not to be construed as limiting the invention. Various of modifications to the present invention can be made to the exemplary embodiments by those skilled in the art without departing from the true spirit and scope of the invention as defined by the appended claims.

What is claimed is:

1. A waterproof microphone comprising:
a transducer unit defining a sound receiving opening;
a first waterproof layer fully covering the sound receiving opening;
a second waterproof layer spaced from the first waterproof layer for forming a closed decompression chamber.

2. The waterproof microphone as described in claim 1 further comprising a board located between the first waterproof layer and the second waterproof layer.

3. The waterproof microphone as described in claim 2, wherein the board defines a central hole serving as the closed decompression chamber.

4. The waterproof microphone as described in claim 2, wherein the board defines a concave area for receiving the second waterproof layer.

5. The waterproof microphone as described in claim 1 further comprising a housing defining a sound hole fully covered by the second waterproof layer.

6. The waterproof microphone as described in claim 1 further comprising a housing having a top and a side extending perpendicularly from the top, the top being located between the first waterproof layer and the second waterproof layer.

7. The waterproof microphone as described in claim 6, wherein the top of the housing defines a sound hole with one side covered by the first waterproof layer and another side covered by the second waterproof layer.

8. The waterproof microphone as described in claim 6 further comprising a shell surrounding the housing.

9. The waterproof microphone as described in claim 8 further comprising a plurality of protrusions arranged between the side of the housing and the shell.
